(19) United States
(12) Patent Application Publication
(10) Pub. No.: US 2026/0228672 A1
(43) Pub. Date: Aug. 6, 2026

(54) DYNAMIC DATA MODEL UPDATING FOR ORGANIZATION MANAGEMENT

(71) Applicant: Aaron J. Cohen, Keller, TX (US)

(72) Inventor: Aaron J. Cohen, Keller, TX (US)

(21) Appl. No.: 19/463,832

(22) Filed: Jan. 29, 2026

Related U.S. Application Data
(60) Provisional application No. 63/752,084, filed on Jan. 31, 2025.

(51) Int. Cl. G06Q 10/067; G06Q 10/0631; G06Q 10/0637

(52) U.S. Cl. CPC G06Q 10/067; G06Q 10/0637; G06Q 10/063116

(57) ABSTRACT

A method includes communicably coupling a plurality of data models. The method includes receiving at least one data change associated with at least one data model of the plurality of data models, the at least one data change associated with a data type. The method includes, responsive to receiving the at least one data change, determining, based on the data type, a subset of data models of the plurality of data models. The method includes determining a set of data changes based on the subset of data models and the at least one data change. The method includes dynamically updating each data model of the subset of data models based on the set of data changes.

### TECHNICAL FIELD

The present disclosure generally relates to updating data models for managing organization-level information, and more specifically relates to coordination of field deployment information based on multiple data sources.

### BACKGROUND

Organizations such as militaries, police departments, government organizations, and emergency medical services deploy personnel, equipment, and/or other assets in the field in response to planned and unplanned events. To ensure readiness, these organizations must rely on accurate data to support operational planning, coordination, and decision-making. Traditionally, the data needed for field deployments is collected and maintained on a localized basis and may be difficult to manage, access, and/or verify both during emergencies and for long-term planning. Further, users associated with the organizations lack access to the most current information in a timely manner and/or can access data that is out of date. Inconsistencies arising from data errors can result in undesirable results, reduced efficacy of a field deployment, and can provide a false understanding of readiness, compliance, and performance.

Therefore, there is a need, for organizations that conduct field operations, for an improved system for managing data/information and for dynamic displaying of updated information to reduce the likelihood of data errors and improve the accessibility of updated and current information.

### SUMMARY

In some embodiments, a method includes communicably coupling a plurality of data models. The method includes receiving at least one data change associated with at least one data model of the plurality of data models, the at least one data change associated with a data type. The method includes responsive to receiving the at least one data change, determining, based on the data type, a subset of data models of the plurality of data models. The method includes determining a set of data changes based on the subset of data models and the at least one data change. The method includes dynamically updating each data model of the subset of data models based on the set of data changes. The method includes displaying a graphical user interface including real-time representations of the updated plurality of data models.

In some embodiments, a system includes a memory and a processor operatively coupled to the memory. The processor is configured to communicably couple a plurality of data models, receive at least one data change associated with at least one data model of the plurality of data models, the at least one data change associated with a data type, responsive to receiving the at least one data change, determine, based on the data type, a subset of data models of the plurality of data models, determine a set of data changes based on the subset of data models and the at least one data changes, dynamically update each data model of the subset of data models based on the set of data changes, and display a graphical user interface including real-time representations of the updated plurality of data models.

In some embodiments, a non-transitory processor-readable medium storing code representing instructions to be executed by one or more processors. The instructions include code to cause the one or more processors to communicably couple a plurality of data models, receive at least one data change associated with at least one data model of the plurality of data models, the at least one data change associated with a data type, responsive to receiving the at least one data change, determine, based on the data type, a subset of data models of the plurality of data models, determine a set of data changes based on the subset of data models and the at least one data changes, dynamically update each data model of the subset of data models based on the set of data changes, and display a graphical user interface including real-time representations of the updated plurality of data models.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for coordinating field deployment information.

FIG. 2 is a block diagram illustrating the example at least one technician device, at least one group member device, at least one administrator device, coordination service, coordination database, and at least one provider service from the architecture of FIG. 1 according to certain aspects of the disclosure.

FIGS. 3-16 are example illustrations of screenshots of displays on the example at least one technician device, at least one group member device, at least one administrator device of FIG. 2.

FIG. 17 is block diagram illustrating an example computer system with which the example at least one technician device, at least one group member device, at least one administrator device, coordination service, coordination database, and at least one provider service of FIG. 2 can be implemented.

FIG. 18 is a flow chart of a method for dynamic updating of data models, according to an embodiment.

FIG. 19 is a flow chart of a method for updating equipment profiles, according to an embodiment.

FIG. 20 is a flow chart of a method for updating user profiles, according to an embodiment.

FIG. 21 is a flow chart of a method for updating a schedule, according to an embodiment.

FIG. 22A is a flow chart of a method for executing an evidence collection, according to an embodiment.

FIG. 22B is a flow chart of a method for generating a blast model, according to an embodiment.

FIG. 23 is a flow chart of a method for generating a budget report, according to an embodiment.

FIG. 24 is a flow chart of a method for automatically updating a data management system, according to an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides systems and methods for updating data models for organizational-level information and for coordinating field deployment information based on active event data as well as historical data. Specifically, the disclosed technology allows for integrated operational management for organizations that conduct field operations, training, deployment, and mission-critical activities by managing personnel, equipment, training, certification, scheduling, financial data, and/or operational data and dynamically disseminating mission-critical information to such personnel including personnel in the field. As will be described in detail below, the disclosed technology can update data models based on a variety of inputs and/or data, disseminate deployment information based on active event data, as well as historical data, associated with a deployment incident to pertinent group members associated with the deployment incident. The disclosed technology improves access to deployment information by securely centralizing storage of the deployment information and, in turn, advantageously increases the speed of disseminating the deployment information. Further, the disclosed technology allows for full operational lifecycle management by allowing for planning, execution, evaluation, and sustainment of field operations across multiple organizational layers.

As used here, “field,” “field operation,” “field deployment,” and/or the like refers to operations, deployments, and/or areas outside of an organization's usual facilities or controlled environments. For example, a “field” can refer to areas outside of organizations'properties/facilities such as offices, training grounds, fixed installations, and/or similar environments. Specifically, the “field” can refer to temporary sites, mobile locations, event locations, remote locations, and/or the like. “Field deployments” can also refer to special circumstances on an organization's properties/facilities such as a range demolition, enhanced training, exercise and/or other activity where monitoring may be desired.

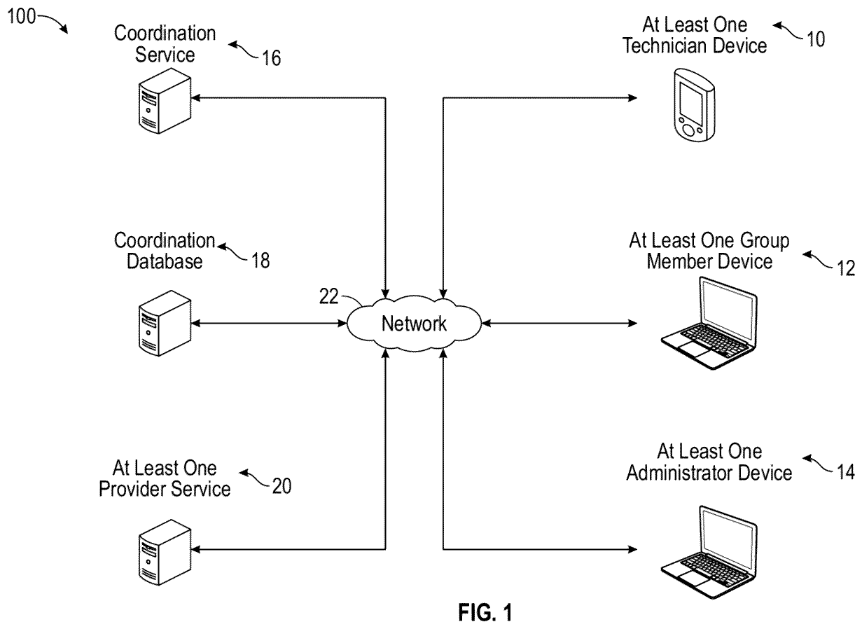

FIG. 1 illustrates an example architecture 100 for coordinating field deployment information based on active event data. For example, the architecture 100 includes at least one technician device 10, at least one group member device 12, at least one administrator device 14, a coordination service 16, a coordination database 18, and at least one provider service 20 all connected over a network 22.

The at least one technician device 10, to which the at least one group member device 12, the at least one administrator device 14, the coordination service 16, the coordination database 18, and the at least one provider service 20 communicate with over the network 22, can be, for example, a tablet computer, a mobile phone, a mobile computer, a laptop computer, a portable media player, an electronic book (eBook) reader, a desktop computer, or other device having appropriate processor, memory, and communications capabilities. Similarly, the at least one group member device 12, to which the at least one technician device 10, the at least one administrator device 14, the coordination service 16, the coordination database 18, and the at least one provider service 20 communicate with over the network 22, can be, for example, a tablet computer, a mobile phone, a mobile computer, a laptop computer, a portable media player, an electronic book (eBook) reader, a desktop computer, or other device having appropriate processor, memory, and communications capabilities. Similarly, the at least one administrator device 14, to which the at least one technician device 10, the at least one group member device 12, the coordination service 16, the coordination database 18, and the at least one provider service 20 communicate with over the network 22, can be, for example, a tablet computer, a mobile phone, a mobile computer, a laptop computer, a portable media player, an electronic book (eBook) reader, a desktop computer, or other device having appropriate processor, memory, and communications capabilities. In the some embodiments, the network 22 can include a radio system configured to transmit information from a user directly and/or remotely to the at least one technician device 10, the at least one group member device 12, the at least one administrator device 14, the coordination service 16, the coordination service 18, and/or the at least one provider service 20.

The coordination service 16 can be a device having an appropriate processor, memory, and communications capability for communicating with the at least one technician device 10, the at least one group member device 12, the at least one administrator device 14, the coordination database 18, and the at least one provider service 20. For purposes of load balancing and/or data backup, the coordination service 16 may include multiple servers.

The coordination database 18 can be a device having an appropriate processor, memory, and communications capability for communicating with the at least one technician device 10, the at least one group member device 12, the at least one administrator device 14, and the coordination service 16. For purposes of load balancing and/or data backup, the coordination database 18 may include multiple servers.

The at least one provider service 20 can be a device having an appropriate processor, memory, and communications capability for communicating with the at least one technician device 10, the at least one group member device 12, the at least one administrator device 14, and the coordination service 16, and the coordination database 18. For purposes of load balancing and/or data backup, the at least one provider service 20 may include multiple servers.

In certain aspects, the coordination service 16, the coordination database 18, and the at least one provider service 20 can be a cloud computing server of an infrastructure-as-a-service (IaaS) and be able to support a platform-as-a-service (PaaS) and software-as-a-service (SaaS) services.

The network 22 can include, for example, any one or more of a personal area network (PAN), a local area network (LAN), a campus area network (CAN), a metropolitan area network (MAN), a wide area network (WAN), a broadband network (BBN), the Internet, and the like. Further, the network 22 can include, but is not limited to, any one or more of the following network topologies, including a bus network, a star network, a ring network, a mesh network, a star-bus network, tree or hierarchical network, and the like.

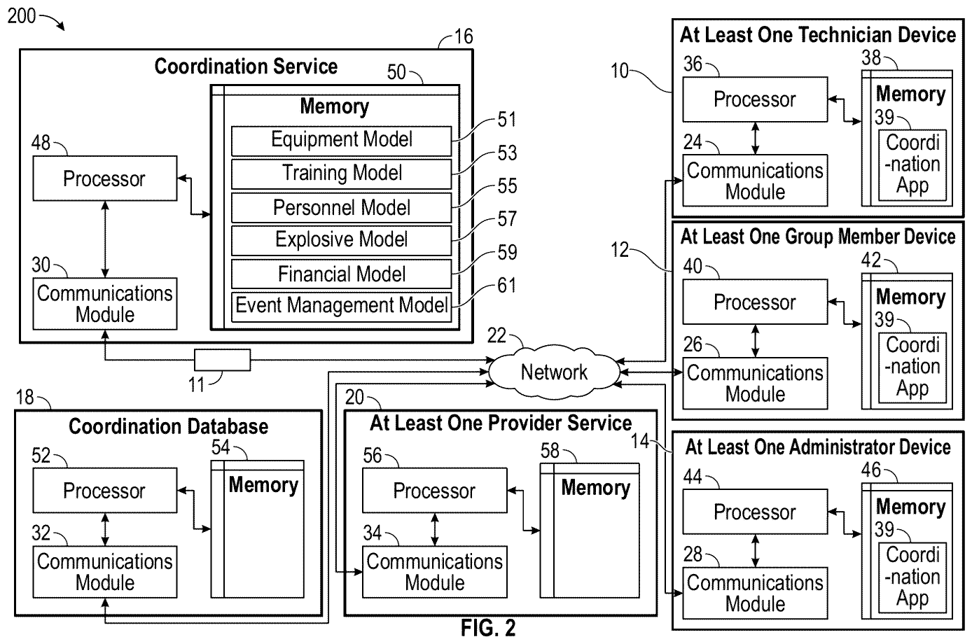

FIG. 2 is a block diagram illustrating examples of the at least one technician device 10, the at least one group member device 12, the at least one administrator device 14, and the coordination service 16, the coordination database 18, and the at least one provider service 20 in the architecture of FIG. 1 according to certain aspects of the disclosure.

The at least one technician device 10, the at least one group member device 12, the at least one administrator device 14, and the coordination service 16, the coordination database 18, and the at least one provider service 20 are connected over the network 22 via respective communication modules 24, 26, 28, 30, 32, 34. The communication modules 24, 26, 28, 30, 32, 34 are configured to interface with the network 22 to send and receive information, such as data, requests, responses, and commands to/from other devices on the network 22. The communications modules 24, 26, 28, 30, 32, 34 can be, for example, modems or Ethernet cards.

The at least one technician device 10 includes a processor 36, the communications module 24, and a memory 38 that includes a coordination app 39. The processor 36 of the at least one technician device 10 is configured to execute instructions, such as instructions physically coded into the processor 36, instructions received from software in the memory 38, or a combination of both. In certain aspects, the coordination app 39 is configured to send and receive information, such as data, requests, responses, and commands to/from the coordination service 16.

The at least one group member device 12 includes a processor 40, the communications module 26, and a memory 42 that includes the coordination app 39. The processor 40 of the at least one group member device 12 is configured to execute instructions, such as instructions physically coded into the processor 40, instructions received from software in the memory 42, or a combination of both. In certain aspects, the coordination app 39 is configured to send and receive information, such as data, requests, responses, and commands to/from the coordination service 16.

The at least one administrator device 14 includes a processor 44, the communications module 28, and a memory 46 that includes the coordination app 39. The processor 44 of the at least one administrator device 14 is configured to execute instructions, such as instructions physically coded into the processor 44, instructions received from software in the memory 46, or a combination of both. In certain aspects, the coordination app 39 is configured to send and receive information, such as data, requests, responses, and commands to/from the coordination service 16.

The coordination service 16 includes a processor 48, the communications module 30, and a memory 50. The processor 48 of the coordination service 16 is configured to execute instructions, such as instructions physically coded into the processor 48, instructions received from software in the memory 50, or a combination of both.

The coordination database 18 includes a processor 52, the communications module 32, and a memory 54. The processor 52 of the coordination database 18 is configured to execute instructions, such as instructions physically coded into the processor 52, instructions received from software in the memory 54, or a combination of both. In some embodiments, the coordination database 18, in the memory 54, can be configured to store data associated with one or more functions associated with the coordination service 16.

The at least one provider service 20 includes a processor 56, the communications module 34, and a memory 58. The processor 56 of the at least one provider service 20 is configured to execute instructions, such as instructions physically coded into the processor 56, instructions received from software in the memory 58, or a combination of both. In some embodiments, the at least one provider service 20 can be configured to execute and/or control one or more functions associated with the coordination service 16.

In many field deployment industries, such as but not limited to, bomb security services, emergency medical services, law enforcement services, search and rescue, and other appropriate industries, technicians in those particular field deployment industries are deployed to an in-field incident (e.g., field deployment) and may require resources and may need to update group members in real-time while in the field. Further, prior to the field deployment, an organization administrator may monitor available resources, including equipment, assets, and personnel, to review availability, changes, costs, and/or the like. The disclosed technology provides those technicians with readily available and time sensitive access to resources such as, but not limited to, publications, documents, tools, in-field training, expert advice, command dashboards, available resources, equipment usage information, financial forecasting, and/or other appropriate resources. Specifically the disclosed technology can allow for managers, commanders, administrators, and/or the like to operate a field-based organization as a unitary enterprise rather than disconnected functional groupings.

While the disclosed technology can be applied to many different industries, as noted above, particular reference to the bomb security industry will be described for exemplarily purposes.

The processor 48 of the coordination service 16 is configured to support productivity software, collaboration, and cloud-based services including enterprise services. Each user associated with any of the at least one technician device 10, the at least one group member device 12, and the at least one administrator device 14 is associated with a profile that is recognized, after attestation, by the processor 48 of the coordination service 16.

The coordination service 16 is configured to receive, via the communications module 30, data 11. The data 11 can include data from any acceptable data source such as the coordination database 18, the at least one provider service 20, the at least one technician device 10, the at least one group member device 12, and/or the at least one administrator device 14. In some embodiments, the data 11 can be a data change which can include information associated with an addition, subtraction, and/or modification to the data already included within the memory 50 of the coordination service 16.

In some embodiments, the coordination service 16 is configured to automatically receive the data 11 from the data source when the data source receives the data 11. Specifically, the data sources can be configured to automatically send the data 11 when received and/or generated. For example, if a user enters a user input into the at least one technician device 10, the data 11 is automatically sent from the at least one technical device 10 to the coordination service 16. In some embodiments, the data sources can send data 11 periodically regardless if new data 11 has been generated and/or received. Periodic sending of the data 11 can allow for the coordination service 16 to verify communication with the data sources and to determine if the data stored within the coordination service 16 is current. In some embodiments, the coordination service 16 can be configured to monitor the memory 54, the memory 58, the memory 38, the memory 42, and/or the memory 46 to determine if the data stored in the monitored memory is different than the data stored in the memory 50 and/or the memory 54 of the coordination database 18. If the coordination service 16 detects a difference, the difference in data (e.g., a data change) can be sent from the source where the difference was detected to the coordination service 16 as the data 11.

In some embodiments, the data 11 can include equipment information (e.g., equipment type, serial numbers, quantity, age, cost, repair information, usage information, etc.), personnel information (e.g., training, scheduling, certification, availability, location, etc.), requests for information, incident information, event information, and/or the like. In some embodiments, the data 11 is stored in the memory 50. In some embodiments, the data 11 or a backup of the data can be stored in the coordination database 18.

The memory 50 of the coordination service 16 includes a plurality of data models configured to model relationships between data. In some embodiments, the plurality of data models are configured to represent physical assets, personnel, equipment, and/or the like. In some embodiments, at least a portion of the data associated with the plurality of data models can be stored and maintained by the coordination database 18. In certain aspects, the memory 50 includes an equipment model 51, a training model 53, a personnel model 55, an explosive model 57, a financial model 59, and an event management model 61. However, in some embodiments, the memory 50 can include fewer, additional and/or other models. For example, the memory 50 can include models configured to represent other and/or additional assets, features, and/or aspects of an organization. For example, if the coordination service 16 is associated with a medical response organization, the memory 50 can include models associated with medical equipment, medicine, ambulances, hospitals, and/or the like.

Generally, the memory 50 can include instructions for managing the plurality of data models (e.g., the equipment model 51, the training model 53, the personnel model 55, the explosive model 57, the financial model 59, the event management model 61, and/or the like) within the memory 50. In some embodiments, one or more of the data models can be stored within another memory such as the memory 54 of the coordination database 18, the memory 58 of the at least one provider service 20, the memory 38 of the at least one technician device 10, the memory 42 of the at least one group member device 12, and/or the at least one administrator device 14. In some embodiments, the data models are interrelated and/or share the same data (e.g., within the coordination database 18). For example, the data models can be a digital twin of an organization having physical assets. Specifically, changes to a subset of data and/or to a data model can automatically update other data and/or data models. Managing the plurality of data models can include aggregating a plurality of data streams (e.g., from the at least one technician device 10, the at least one group member device 12, the at least one administrator device 14, the at least one provider service 20, and other appropriate devices). For example, during operation, the memory 50 can include instructions for operational event management, personnel deployment and assignment, training and certification tracking, equipment and inventory management, capability-based budgeting and lifecycle modeling, post-incident reporting and after-action analysis, and/or organizational readiness and compliance report, as further described below. In some embodiments, one or more operations of the coordination service 16 as described herein can be controlled, modified, and/or monitored by a user via the coordination app 39. For example, the coordination app 39 can be used to display information associated with the coordination service 16.

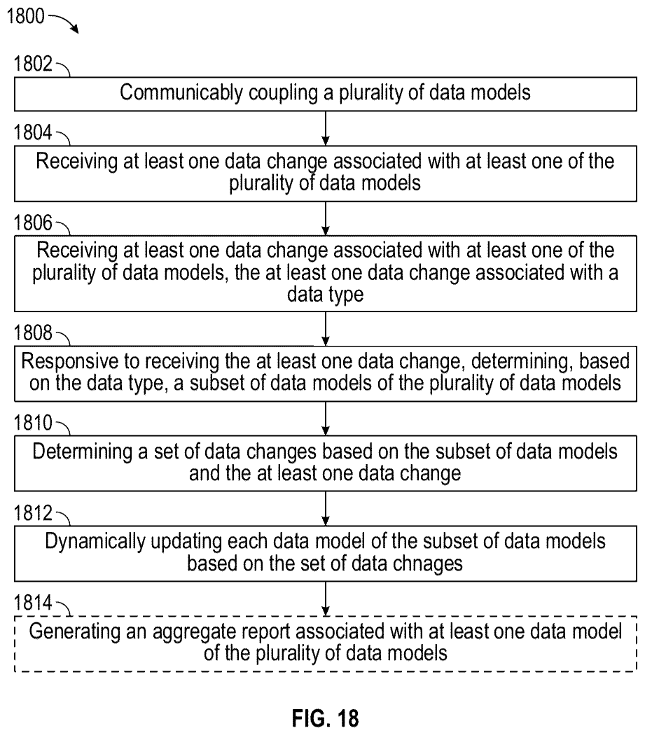

FIG. 18 shows a flow chart of a method 1800 for dynamically updating a plurality of data models, as generally described above. The method 1800 can be stored as instructions in the memory 50 (e.g., and/or other memories) for execution by the processor 48 of the coordination service 16. At 1802, the method 1800 includes communicably coupling the plurality of data models. For example, communicably coupling the plurality of data models can include generating and/or determining relationships between data models, between data within data models, and/or the like. In some embodiments, coupling the plurality of data models can be based on historical information (e.g., existing information, etc.) and/or inputs (e.g., new information, etc.).

At 1804, the method 1800 includes receiving, at the coordination service 16, at least one data change, such as the data 11, associated with at least one data model of the plurality of data model, the at least one data change associated with a data type. For example, the at least one data change can include an input received from one or more of the at least one technician device 10, the at least one group member device 12, the at least one administrator device 14, the at least one provider service 20, and/or the like. In some embodiments, the at least one data change can be detected automatically (e.g., via monitoring one or more data models) or received manually (e.g., inputted by a user).

The at least one data change can be any information associated with altering the plurality of data models. For example, the at least one data change can include information for changing, replacing, augmenting, and/or removing information from one or more of the plurality of data models. The data type describes how the data is related to other data and/or data models. In some embodiments, the data type is chosen (e.g., by the user, via a look-up table, automatically, etc.) from a predetermined list of data types. For example, each possible data change can include an associated data type that is predetermined and assigned when received by the coordination service 16.

At 1806, the method 1800 includes, responsive to receiving the at least one data change, determining, based on the data type, a subset of data models of the plurality of data models. For example, if a data type is “training activity,” the data type may be associated with a training model, a personnel model, a financial model and/or an equipment model as training activity can affect certification status, certification status can affect eligibility for deployment, deployments affect equipment usage and cost, and equipment usage affects life cycle budget planning. In some embodiments, subsets of data models associated with each data type are predetermined. In some embodiments, the subset of data models can be determined automatically (e.g., by a machine learning model) and/or manually. For example, a machine learning model can be trained to identify how a data change of a specific data type can affect the plurality of data models.

At 1808, the method 1800 includes determining a set of data changes based on the subset of data models and the at least one data change. The set of data changes include downstream data changes that would be affected by the at least one data change received at 1804. In some embodiments, the set of data changes can be determined automatically or manually. In some embodiments, the set of data changes can be determined by using a look-up table and the data type. In some embodiments, the set of data changes can be determined by a machine learning model trained to determine down-stream effects of data changes. For example, the machine learning model can be trained on historical data associated with prior deployments, organizational records, and/or the like. In some embodiments, the set of data changes can include past, current, and/or future data changes. For example, the set of data changes can include data changes indicating that current data is out of data. As another example, the set of data changes can include provisional changes that can be executed at a predetermined time, after a predetermined period of time, and/or based on a triggering event (e.g., input, data change, specific event, and/or the like).

At 1810, the method 1800 includes dynamically updating each data model of the subset of data models based on the set of data changes. Dynamically updating can include automatically updating each data model. For example, dynamically updating can include simultaneously and/or immediately updating the subset of data models once the set of data changes is determined. In some embodiments, dynamically updating can include updating dependencies associated between data models and/or data. For example, the dependencies can allow for the changes to be traceable and/or can allow for a user to review data interdependencies within a data model and/or between data models. In some embodiments, dynamic updating can include updating data models directly and/or setting up provisional data changes (e.g., time based changes, future changes, and/or the like).

At 1812, the method 1800 optionally includes generating an aggregate report associated with at least one data model of the plurality of data models. The aggregate report can include an overview of one or more of the data models. For example, the aggregate report can include operational management reports (e.g., period reports). The aggregate report can allow for a user to review organizational health, readiness, capability coverage, financial exposure, and/or risk. Specifically, the aggregate report can include at least one of personnel availability and qualifications, training and certification compliance, equipment sufficiency and lifecycle status, deployment speed and historical utilization, budgets, costs associated with operational capability, gaps in coverage, and/or readiness.

In some embodiments, the method 1800 can include displaying a graphical user interface including real-time representations of the updated plurality of data models. In some embodiments, the real-time representations can represent the aggregate report. The graphical user interface can be displayed on at least one of the at least one technician device 10, the at least one group member device 12, the at least one administrator device 14, and/or the at least one provider service 20. The real-time representations are graphical representations that are configured to reflect the most current information within the plurality of data models. The real-time representations are configured to be updated every time a data change is received and/or detected to constantly update the graphical user interface and provide a user with updated information to reduce the likelihood of a user accessing and/or using outdated information. In some embodiments, user inputs can include interactions (e.g., user interactions) with the graphical representations and can cause changes in the graphical user interface such as different representations of information being displayed.

In some embodiments, the aggregate report can highlight the impact of data changes compared to a previously generated report. In some embodiments, the aggregate report can be generated in response to a signal indicating that an aggregate report is desired (e.g., from at least one administrator device 14, etc.). In some embodiments, the aggregate report is generated automatically, periodically, and/or the like. In some embodiments, the aggregate report can be generated for updating a dashboard. For example, the aggregate report can be used to update a dashboard including information on the data models. The dashboard can be stored by the coordination service 16, the coordination database 18, the at least one provider service 20, and/or the like. A user, via the at least one technician device 10, the at least one group member device 12, and/or the at least one administrator device 14, can access the dashboard to access current and predicted (e.g., dynamically updated) information associated with the plurality of data models.

The equipment model 51 is a data model including instructions associated with storing and managing information associated with equipment (e.g., useable assets, devices, vehicles, explosives, etc.) associated with the organization. The equipment model 51 can include information such as equipment inventory, equipment usage information, equipment capabilities, equipment repair schedule, equipment costs, equipment depreciation, and/or the like. The equipment model 51 allows for an accurate and updated model for a user to review equipment available for field deployments and/or for forecasting associated with the equipment usage. In some embodiments, the equipment can be associated with explosives.

The equipment model 51 is further configured to provide an inventory of equipment and to monitor accountability by coordinating equipment with personnel, operations, and/or the like. The coordination can include digitally tracking, monitoring usage, and/or auditing of equipment owned by the organization and stored in one or more location.

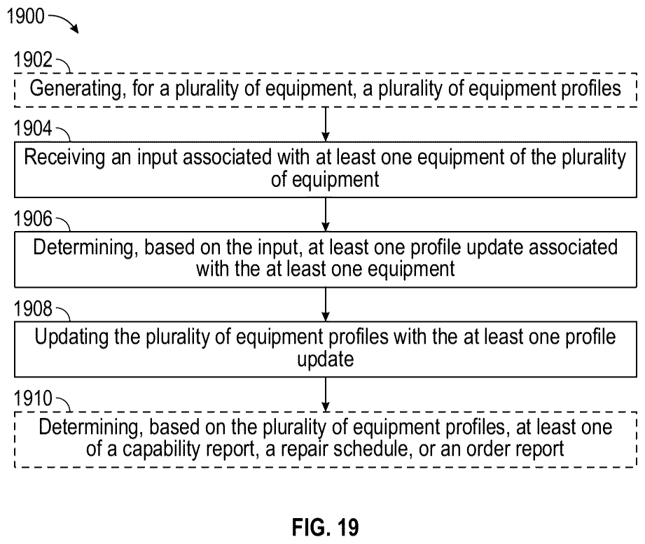

FIG. 19 is a flow chart of a method 1900 for updating equipment profiles. The method 1900 can be stored as instructions in the memory 50 (e.g., and/or other memories), such as in the equipment model 51, for execution by the processor 48 of the coordination service 16. At 1902, the method 1900 optionally includes generating, for a plurality of equipment, a plurality of equipment profiles. Each of the equipment profiles can include information on the equipment such as type, usage, history, and/or the like. In some embodiments, the equipment profiles can be generated based on historical information associated with the organization. In some embodiments, the equipment can be associated with a specific operational capability. For example, an operational capability can be associated with an equipment type, a quantity of equipment, a functional role of the equipment, equipment compatibility, and/or the like. For example, an operational capability can indicate that multiple types of x-ray systems, robots, disruptors, or protective equipment are desired for an operation.

In some embodiments, for example, the equipment profiles can be generated for explosives to digitally track explosive material associated with physical storage locations (e.g., magazines). In some embodiments, the equipment profiles for explosives can include explosive type(s), weights, lot numbers, and/or other identifying information. In some embodiments, the equipment profiles can include information associated with audits, certification of bunker locations, usage, budgeting reports, and/or the like.

At 1904, the method 1900 includes receiving, at the coordination service 16, an input associated with at least one equipment of the plurality of equipment. In some embodiments, the input is a draw request indicating that the equipment is desired for usage. The draw request may be associated with a person, group of people, an operation, and/or the like. As an example, the draw request can include a request to remove explosive from a magazine for use in training, deployment, or another operation. In some embodiments, each input can be associated with a personnel identifier, a time-stamp, an event identifier, an activity identifier, a quantity, and/or an equipment type.

In some embodiments, the input is associated with equipment usage, damage, and/or destruction. For example, the input can include what equipment was used, how much equipment was used, how much equipment was disabled, how much equipment was damaged, and/or how much equipment was returned to storage. The input can include information associated with job-order costing and can allow for tracking the true-cost (e.g., lifetime cost, etc.) associated with deployments.

At 1906, the method 1900 includes determining, based on the input, at least one profile update associated with the at least one equipment. The at least one profile update can include one or more change to associated equipment profile(s). In some embodiments, the at least one profile update is determined automatically based on an input type and/or the type of data included in the input. For example, if a certain amount of material is used, the at least one profile update can include a subtraction of material from an associated equipment profile. At 1908, the method 1900 includes updating the plurality of equipment profiles with the at least one profile update. Updating the equipment profiles allows for maintained profiles of the equipment so that a user can determine a current state of the equipment. For example, a balance can be maintained and continuously updated for each storage location based on initial quantities, draw transactions, usage records, and returns to establish a digital representation (e.g., digital twin) of the storage locations.

At 1910, the method 1900 optionally includes determining, based on the plurality of equipment profiles, at least one aggregate report such as, but not limited to, a capability report, a repair schedule, or an order report. The capability report can be an equipment profile that indicates what capabilities an organization has based on the available equipment. In some embodiments, the capability report can further include personnel counts to indicate a quantity of each equipment type desired based on the number of authorized and/or assigned users for a given capability. In some embodiments, a repair schedule can include maintenance schedules associated with equipment based on current and/or future expected usage. In some embodiments, the order report can indicate gaps in the current and/or future equipment supply so that a user can order new and/or additional equipment.

In some embodiments, additional and/or other reports can be generated. For example, an audit ledger can be generated for equipment. The audit ledger can include personnel identifiers, timestamps associated with usage, event identifier, transaction types (e.g., request, use, destruction, return, etc.), quantities, and/or the like. The audit ledger can provide a chain of custody for equipment. For example, for explosives, the chain of custody for the explosive materials can be followed from receipt of material through final disposition (e.g., use).

In some embodiments, inventory and/or compliance reports can be generated. For example, the inventory and/or compliance reports can include total equipment issued over a reporting period, equipment in storage, equipment used by event, deployment, or user, and/or discrepancies and/or variance between expected and recorded balances.

In some embodiments, the information associated with the equipment model 51 can be used (e.g., integrated) with deployment, training, and after-action reporting such that the equipment usage is automatically associated with specific incidents, training, and/or other events or activities. Thus, allowing for administrators such as commanders, supervisors, auditors and/or the like real-time access to where equipment is available, where equipment is stored, how equipment was used, and/or whether inventory balances are within expected limits.

The training model 53 is a data model including instructions associated with storing and managing information associated with personnel training and/or certification. Specifically, the training model 53 can include instructions associated with event creation, registration, and selection. The training model 53 is configured to create a training event and to enable personnel to register for events via an approval and selection process. In some embodiments, an administrator (e.g., via the at least one administrator device 14) is configured to control at least a portion of the operation of the training model 53.

For example, an administrator (e.g., via the at least one administrator device 14) can create an event by generating an input associated with the event. The input can include an event type (e.g., training event, deployment event, etc.). In some embodiments, the input can include a location, a start date, an end date, total hours, associated times, associated qualifications, number of available positions, and/or additional information.

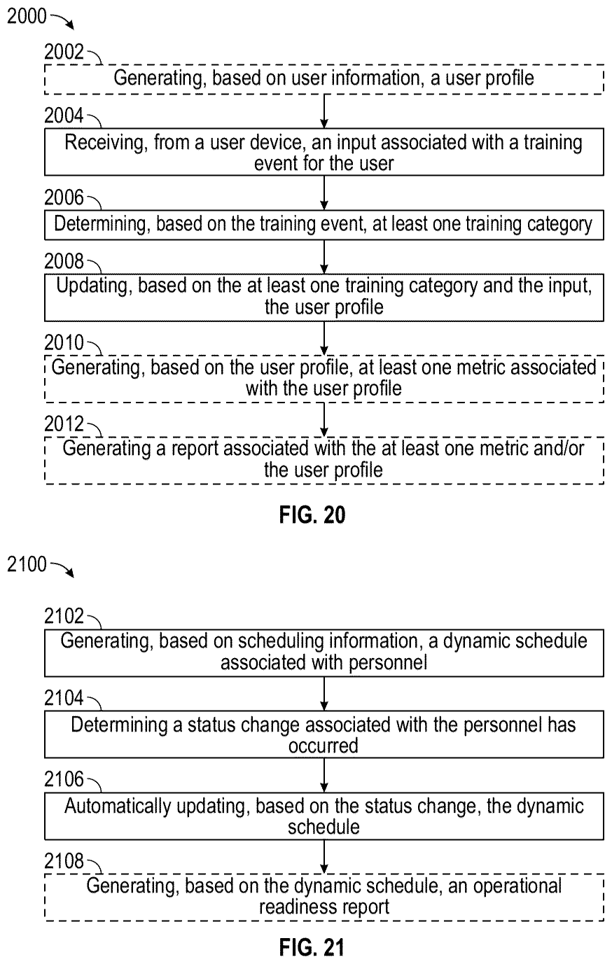

FIG. 20 is a flow chart of a method 2000 for updating user profiles. The method 2000 can be stored as instructions in the memory 50 (e.g., and/or other memories), such as in the training model 53, for execution by the processor 48 of the coordination service 16. At 2002, the method 2000 optionally includes generating, based on user information, a user profile. The user information can include historical information associated with one or more user (e.g., personnel). For example, the user information can include past trainings, experiences, deployment information, and/or the like. Based on the user information, the user profile can be generated to include operational capabilities. For example, the operational capabilities can include explosive rendering safe, manual entry techniques, robotic operations, equipment proficiency, post-blast investigation, and/or other response functions.

At 2004, the method 2000 includes receiving, from a user device, an input associated with a training event for the user. In some embodiments, the user device can include at least one of the at least one technician device 10, the at least one group member device 12, the at least one administrator device 14, and/or the at least one provider service 20. In some embodiments, prior to 2004, a training event creation signal can be received. Once the training event creation signal is received, the training event is generated and displayed to one or more associated user.

The input associated with the training event can include a registration request. The registration request can be associated with a personnel identifier for the requesting user. Once the input is received, information associated with the user profile can automatically be associated with the registration request to generate a candidate evaluation package. In some embodiments, the candidate evaluation package can include at least one of total deployment, deployment types, training hours, certification status, equipment proficiency, and/or prior event participation. In some embodiments, the registration request can be approved automatically based on the user profile. In some embodiments, the registration request can be approved by an administrator. In some embodiments, candidate evaluation packages can be sent to multiple approval systems in a ranked or comparative format. In some embodiments, request, approvals, and training outcomes are further stored and/or associated with the user profile. In some embodiments, approvals, rejections, and/or the like are communicated to the user via a notification such as an e-mail, electronic message, notifications, and/or the like.

At 2006, the method 2000 includes determining, based on the training event, at least one training category. For example, the training category can be associated with a daily training activity, a certification-level training event, and/or the like. In some embodiments, the training category can include, but is not limited to, a specific skill such as x-ray, robot operation, bomb suit, disruption device, post-blast analysis, and/or the like, and other appropriate training category. In some embodiments, the training category can include specific equipment training such as Quatro x-ray, ScanSilk x-ray, robot model, hydrojet, percussion actuated disruptor, and/or the like. The category can be user identified or can be automatically determined based on the type of training and/or description of the training.

At 2008, the method 2000 includes updating, based on the at least one training category and the input, the user profile. For example, the user profile can have a certification updated if the training was associated with a certification. The user profile can be updated with the time spent on the training, the training category, any changes to user capabilities, and/or the like.

At 2010, the method 2000 optionally includes generating, based on the user profile, at least one metric associated with the user profile. The at last one metric can include a competency, a readiness, and/or the like. In some embodiments, the user profile can include training profiles specifically such as a continuing education compliance profile, a certification compliance profile, and/or a team-level training and readiness profile.

At 2012, the method 2000 optionally includes generating a report associated with the at last one metric and/or the user profile. The report can include any information associated with either the user and/or the entire organization. For example, the report can be an aggregated record that can allow an administrator to determine which personnel are associated with desired certification, which personnel have current or expired credentials, which personnel have recent or sustained experience on specific platforms, and/or where training gaps exist. Further, the report can show equipment-specific proficiency metrics such as cumulative time spent on particular platforms and/or equipment to identify areas or strength and where additional training is needed both individually and on an organizational level.

The personnel model 55 is a data model including instructions associated with storing and managing information associated with personnel and how personnel are available. For example, the personnel model 55 can manage availability and readiness information in an operational calendar and reporting system. The personnel model 55 aggregates personnel availability, training schedules, deployment events, on-call status, leave records, and/or the like into unified timeline that is accessible by a plurality of users. The unified timeline can allow a user to determine which personnel are on duty, on call, or unavailable, which training or deployment event are occurring or upcoming, which personnel are assigned to each event, and/or where personnel are located or scheduled to be.

FIG. 21 is a flow chart of a method 2100 for updating a schedule. The method 2100 can be stored as instructions in the memory 50 (e.g., and/or other memories), such as in the personnel model 55, for execution by the processor 48 of the coordination service 16. At 2102, the method 2100 includes generating, based on scheduling information, a dynamic schedule associated with personnel. The scheduling information can include historical calendar data to track events, training activities, and/or personnel movements that are scheduled and/or have occurred. In some embodiments, the personnel model 55 can receive information from the training model 53 to determine training information for the dynamic schedule.

At 2104, the method 2100 includes determining a status change associated with the personnel has occurred. The status change can include training event schedules, deployment schedules, on-call assignments, leave and travel records, individual availability calendars, and/or the like. In some embodiments, the personnel model 55 can be monitoring a plurality of data sources to determine that the status change has occurred. For example, if a user registers for training, the personnel model 55 can determine that a user status change has occurred. At 2106, the method 2100 includes automatically updating, based on the status change, the dynamic schedule. Automatically updating allows for the dynamic schedule to stay up to date with salient information for any personnel in the organization.

At 2108, the method 2100 optionally includes generating, based on the dynamic schedule, an operational readiness report. In some embodiments, the operational readiness report can be generated periodically and/or upon request. In some embodiments, the operation readiness report can include at events that occurred during the prior reporting period, training and deployment schedule for the upcoming reporting period, personnel on leave, on travel, or unavailable, and/or staffing coverage and readiness indicators. The operational readiness report can be automatically sent to one or more user device such as those associated with a commander, supervisor, and/or other authorized stakeholder. The operational readiness report allows for updated and accurate awareness of unit health, readiness, and operational speed without manual compilation.

In some embodiments, for example, the personnel model 55 can generate a future analysis that identifies potential coverage gaps, staffing conflict, or upcoming training and deployment demands based on the dynamic schedule.

The explosive model 57 is a data model including instructions associated with storing and managing information associated with analyzing and modeling explosives and explosive blasts. Specifically, the explosive model 57 is configured to provide a post-incident (e.g., explosive blast) evidence collection system that can enable a user to accurately document, validate, and package post-blast and post-incident forensic evidence. Further, the explosive model 57 is also configured to generate blast effect models and evacuation maps to allow for rapid calculation, visualization, and electronic distribution of projected blast impact and evacuation zones based on explosive-related input data.

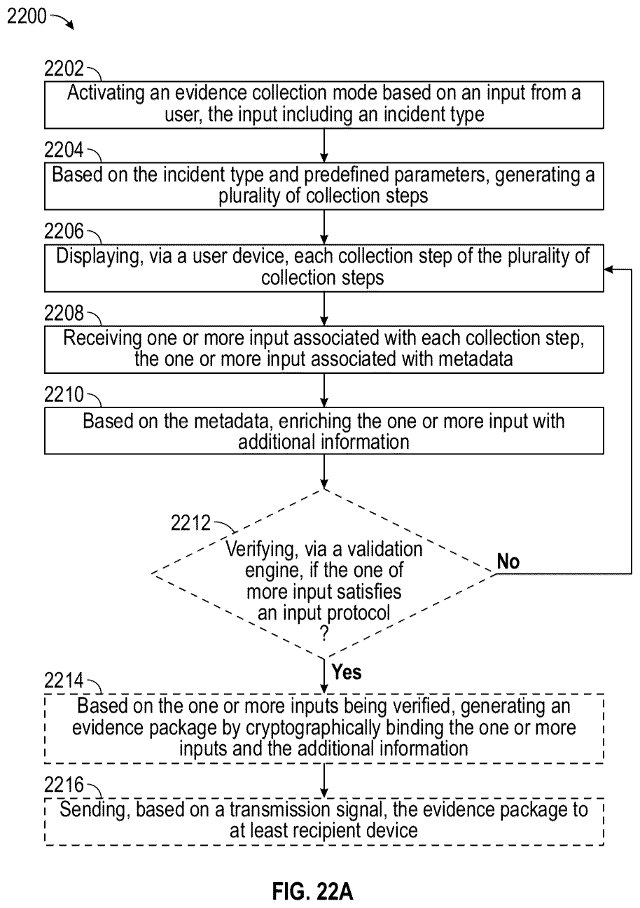

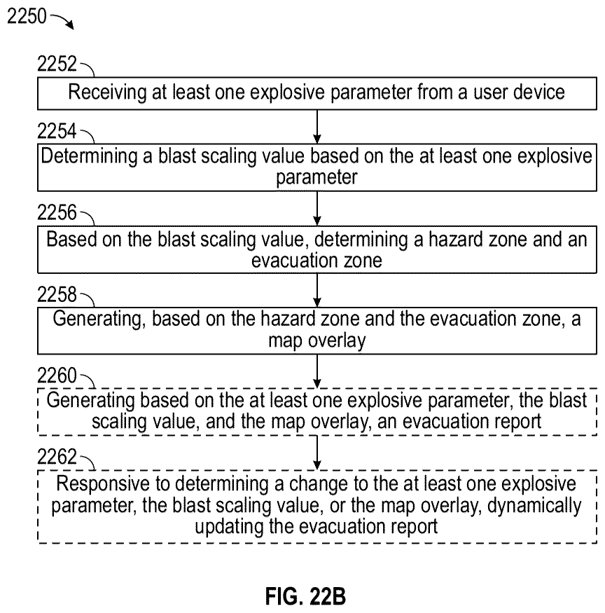

FIG. 22A is a flow chart of a method 2200 for executing an evidence collection. The method 2200 can be stored as instructions in the memory 50 (e.g., and/or other memories), such as in the explosive model 57, for execution by the processor 48 of the coordination service 16.

At 2202, the method 2200 includes activating an evidence collection mode based on an input from a user, the input including an incident type. For example, a user, via the at least one technician device 10, can send an input that a post-blast or post-incident mode is desired. The input can include what the incident was and other information associated with the incident such as location, date, time, and/or the like.

At 2204, the method 2200 includes based on the incident type and predefined parameters, generating a plurality of collection steps. The plurality of collection steps can be collection steps that are stored in a collection database (e.g., within the memory 54 of the coordination database 18). In some embodiments, the collection steps are based on the type of incident, the location, and/or other information. In some embodiments, the predefined parameters are organizational requirements, forensic protocol, and/or the like. As an example, the collection steps can include crater and scene measurement capture, photography of the blast scene and associated items, physical sample collection, swab direction and placement, and/or container selection for each sample type.

At 2206, the method 2200 includes displaying, via a user device, such as the at least one technician device 10, at least one group member device 12, at least one administrator device 14, and/or the at least one provider service 20, each collection step of the plurality of collection steps. In some embodiments, the system can present the collection steps as a series of prompts that can be completed in a predetermined order (e.g., to reduce contamination, etc.). At 2208, the method 2200 includes receiving one or more input associated with each collection step, the one or more input associated with metadata. In some embodiments, the metadata can be captured for each collection step or generally for the incident. In some embodiments, the metadata can include geolocation, timestamps, device identifiers, user identifiers, incident identifiers, and/or the like. At 2210, the method 2200 includes, based on the metadata, enriching the one or more input with additional information.

At 2212, the method 2200 optionally includes, verifying, via a verification engine, if one or more input satisfied an input protocol. For example, the input protocol can be associated with a sufficient amount of information being collected, organizational requirements, and/or the like. For example, the verification engine can confirm if the metadata was collected as desired. If the verification engine determines that the one or more input does not satisfy the input protocol, the method 2200 returns to 2206, and the user can be prompted to enter additional information as a collection step. However, in some embodiments, an administrator can override the verification engine and the method 2200 can continue to 2214.

If the verification engine verifies that the one or more input satisfies the input protocol, the method 2200 continues to 2214. At 2214, the method 2200 optionally includes, based on the one or more inputs being verified, generating an evidence package by cryptographically binding the one or more inputs and the additional information. The evidence package records a chain-of-custody entry that cryptographically binds data within the evidence package to reduce the likelihood of subsequent tampering and/or modification. In some embodiments, the method 2200 can include generating an incident report based on the evidence package that can include at least, but is not limited to, one of collected images, measurements, metadata, validation status, chain-of-custody, and/or the like. In some embodiments, the incident report can be sent to the at least one technician device 10 for review prior to submission.

At 2216, the method 2200 optionally includes sending, based on a transmission signal, the evidence package to at least one recipient device. The recipient device can be associated with a recipient laboratory and/or other evidence processing facility thus allowing for routing of evidence packages and incident report for analysis. The explosive model 57 records each transmission, receipt, and access event in the chain-of-custody to create an audit trail from the incident scene through laboratory intake and analysis. In some embodiments, the evidence package can be sent via a secure portal that provides read-only access to the validated data and associated audit records.

FIG. 22B is a flow chart of a method 2250 for generating a blast model. The method 2250 can be stored as instructions in the memory 50 (e.g., and/or other memories), such as in the explosive model 57, for execution by the processor 48 of the coordination service 16. At 2252, the method 2250 includes receiving, at the coordination service 16, at least one explosive parameter from a user device. In some embodiments, the at least one explosive parameter can include at least one of explosive type, estimated explosive weight, standoff factors, and/or environmental factors. In some embodiments, at least one explosive parameter can include weather information, location, and/or the like. In some embodiments, the at least one explosive parameter can include a user-entered or predetermined safety factor, relative effectiveness factor, and/or the like.

At 2254, the method 2250 includes determining a blast scaling value based on the at least one explosive parameter. For example, the blast scaling value can be a K-factor and/or the like. The blast scaling value is a value that is associated with a projected hazard and evacuation zone. In some embodiments, the blast scaling value can be determined based on a formula, a look-up table, historical data, and/or the like.

At 2256, the method 2250 includes, based on the blast scaling value, determining a hazard zone and an evacuation zone. In some embodiments, the hazard zone and the evacuation zone are areas (e.g., surface areas, volumes, etc.), distances (e.g., away from a central point, etc.), and/or the like. In some embodiments, the hazard zone and evacuation zone can be further based on the geography of the blast location. At 2258, the method 2250 includes generating, based on the hazard zone and the evacuation zone, a map overlay. The map overlay can include a concentric evacuation and hazard zone overlaid on a geographic map. In some embodiments, the map overlay can include streets, buildings, points of interest, and/or the like. The map overlay provides a visual representation of the potential blast and can be used to inform a user about the impact of the blast.

At 2260, the method 2250 optionally includes generating, based on the at least one explosive parameter, the blast scaling value, and the map overlay, an evacuation report. The evacuation report can be a document (e.g., a PDF, etc.) that includes blast information such as the blast scaling factor, predicted hazard and evacuation zones, map overlays, incident identifiers, and/or timestamps. In some embodiments, the evacuation report can include blast information such as damage probability (e.g., to windows, infrastructure, buildings, people, etc.). In some embodiments, the map overlay can include concentric damage rings (e.g., different color rings, etc.) indicating damage extent associated with a blast. In some embodiments, the evacuation report can be automatically distributed to at least one of command staff, emergency responders, emergency operation centers, and/or partner agencies. In some embodiments, the evacuation report is a dynamic (e.g., changeable) document that can be updated. At 2262, the method 2250 optionally includes, responsive to determining a change to the at least one explosive parameter, the blast scaling value, or the map overlay, dynamically updating the evacuation report. Dynamically updating the evacuation report allows all recipients to have access to the most current information to best inform decision making and safety protocols.

The financial model 59 is a data model including instructions associated with storing and managing information associated with the financial projection of an organization. The financial model 59 is configured to update lifecycle, depreciation, and remaining service life values based on usage, maintenance, and operational activity for equipment. In some embodiments, the financial model 59 is configured to send and receive information associated with the equipment model 51. The financial model 59 is able to determine financial exposure per capability and/or mission profile.

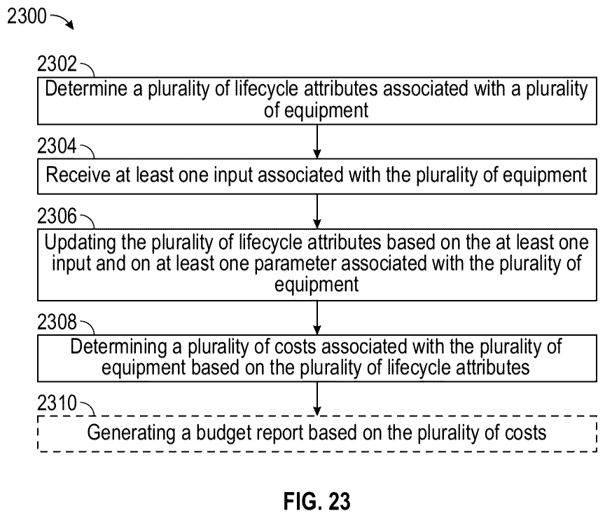

FIG. 23 is a flow chart of a method 2300 for generating a budget report. The method 2300 can be stored as instructions in the memory 50 (e.g., and/or other memories), such as in the financial model 59, for execution by the processor 48 of the coordination service 16. At 2302, the method 2300 includes determining a plurality of lifecycle attributes associated with a plurality of equipment. For example, the plurality of lifecycle attributes can include acquisition cost, service life, depreciation rate, maintenance cost, replacement interval, and/or the like.

At 2304, the method 2300 includes receiving, at the coordination service 16, at least one input associated with the plurality of equipment. The at least one input can include an input indicating equipment usage, new equipment, equipment damage, equipment repairs, and/or the like. At 2306, the method 2300 includes updating the plurality of lifecycle attributes based on the at least one input and on at least one parameter associated with the plurality of equipment. At 2308, the method 2300 includes determining a plurality of costs associated with the plurality of equipment based on the plurality of lifecycle attributes. The plurality of cost can be determined based on expected costs for equipment with the associated lifecycle attributes. In some embodiments, the plurality of costs can include current costs (e.g., pending repairs, replacements, etc.), projected costs (e.g., future repair costs).

At 2310, the method 2300 optionally includes generating a budget report based on the plurality of costs. The budget report can include annualized lifecycle cost for each equipment type and for each operational capability. For example, generating the budget report can include adding associated costs of the plurality of costs for a period of time. The budget report can be a capability budget report that includes required annual spending by capability, required annual spending by equipment type, and projected replacement and sustainment over time. In some embodiments, the budget report can additionally include job-order costing by associating deployed equipment, expendable, and wear-and-tear with specific incidents, missions, or deployments to allow for cost attribution to specific operations.

The event management model 61 is a data model including instructions associated with storing and managing information associated with managing events (e.g., incidents). The event management model 61 is configured to lead a user through an event to connect the user with available resources and to allow for integrated post-incident and after-action reporting that can affect equipment usage, consumption, and/or degradation during deployments.

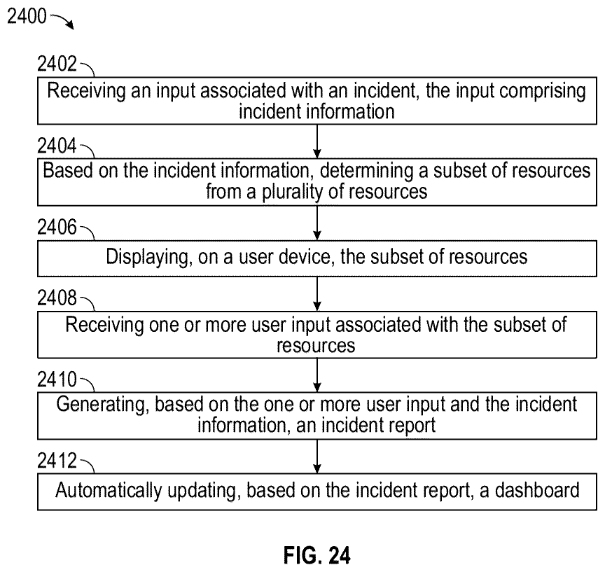

FIG. 24 is a flow chart of a method 2400 for automatically updating a data management system. The method 2400 can be stored as instructions in the memory 50 (e.g., and/or other memories), such as in the event management model 61, for execution by the processor 48 of the coordination service 16. At 2402, the method 2400 includes receiving, at the coordination service 16, an input associated with an incident, the input comprising incident information. The incident information can include an incident type, incident title, incident date, incident time, a location, a summary, images, support, and/or the like.

At 2404, the method 2400 includes, based on the incident information, determining a subset of resources from a plurality of resources. The subset of resources can include resources (e.g., equipment, personnel, etc.) available for the user based on the incident information. For example, the subset of resources can include resources within a predetermined distance of the incident and/or personnel on-call. In some embodiments, the available resources can be based on information associated with the personnel model 55 and/or the training model 53 such as training, availability, certifications, and/or the like. In some embodiments, the available resources can include field resources such as evidence collection, blast monitoring, equipment request, equipment swapping, and/or the like.

At 2406, the method 2400 includes displaying, on a user device such as the at least one technician device 10, the at least one group member device 12, the at least one administrator device 14, and/or the like, the subset of resources. At 2408, the method 2400 includes receiving one or more user input associated with the subset of resources. For example, the one or more user input can include the user selected at least one resource. For example, the user can select to contact one of the resources (e.g., an operator, personnel, etc.). In some embodiments, the one or more user input can include information associated with the incident. At 2410, the method 2400 includes generating, based on the one or more user input and the incident information, an incident report. The incident report can include information associated with the incident such as personnel involved, blast information, equipment used, and/or the like. At 2412, the method 2400 includes automatically updating, based on the incident report, a data management system. The data management system can include a dashboard, or similar accessible data visualization system, configured to allow a user and/or an administrator to review information associated with the incident and/or other incidents. Updating the data management system can include automatically updating computer graphics representing incidents to provide updated information for users.

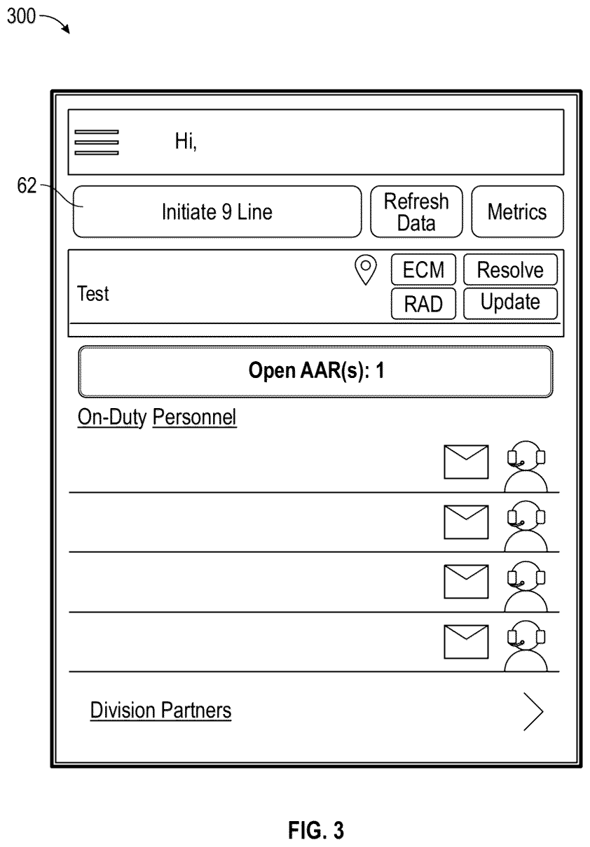

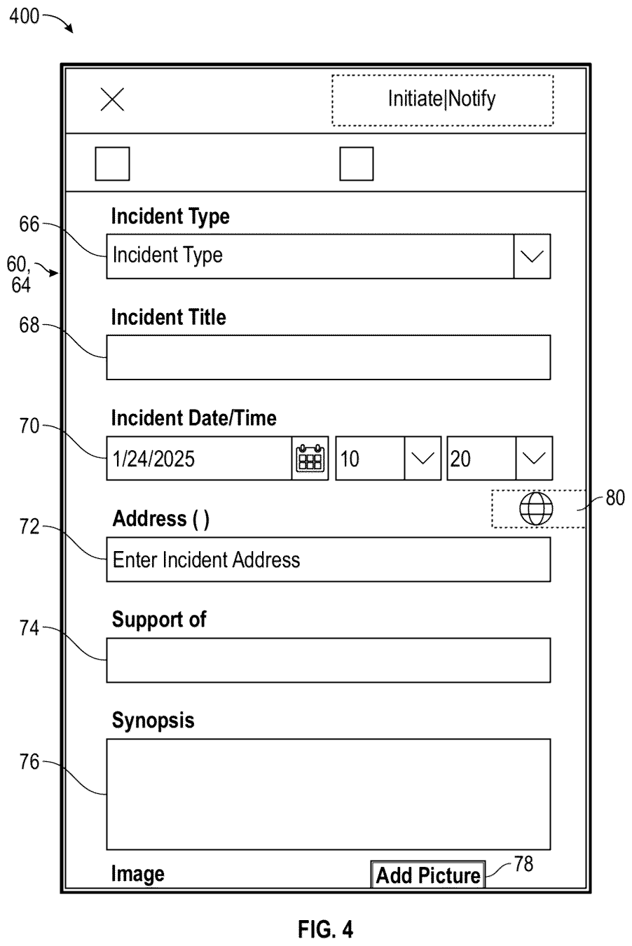

Referring generally to FIGS. 3-16, the method 2400 is generally shown via a set of screenshots showing how a user may interact with a device executing the method 2400. FIG. 24 sets forth an example process 2400 for automatically updating a data management system using the event management model 61 coordination service 16 and/or other devices (e.g., at least one technician device 10, at least one group member device 12, at least one administrators device 14, at least one provider service 20). An example will now be described using the example process 2400 with reference to the example screenshots depicted in FIGS. 3-16. The example screenshots of graphical user interfaces (GUIs) depicted in FIGS. 3-16 are below described with reference to the at least one technician device 10, the at least one group member device 12, the at least one administrator device 14, and the coordination service 16, the coordination database 18, and the at least one provider service 20 of FIG. 2. The processor 48 of the coordination service 16 is configured to receive event data (e.g., 9 Line information) from the at least one technician device 10. With particular reference to the screenshot 300 of FIG. 3, the event data can be input into the at least one technician device 10 by a user. For example, the processor 36 of the at least one technician device 10, via the coordination app 39, is configured to receive the event data 60, responsive to selection of the Initiate button 62, by displaying a plurality of event data fields 64, as illustrated in the screenshot 400 in FIG. 4. The plurality of event data fields 64 include, but is not limited to, an incident type field 66, an incident title field 68, an incident date and time field 70, an address field 72, a support field 74, a synopsis field 76, and other appropriate fields. Additional fields can be activated based on the type of response the technician engages in. Responsive to selection of an add picture button 78, the processor 36 of the at least one technician device 10, via the coordination app 39, is configured to accept uploads of pictures and to transmit the pictures to the coordination service 16, which can be stored in the coordination database 18. In certain aspects, after receiving the pictures, the processor 48 of the coordination service 16 is configured to access an artificial intelligence service to identify items in the pictures, which may be predetermined items, in order to assist in identification and analysis.

The coordination app 39 allows a user of the at least one technician device 10, such as, but not limited to, a bomb technician, an emergency medical technician, and other appropriate technicians, to report (e.g., transmit the event data 60 to the coordination service 16) current or upcoming incidents that are planned or unplanned. The incident type that is selected by drop down box of the incident type field 66 is transmitted by the coordination app 39 to the coordination service 16, which analyzes and determines, for example, what level of response notifications are published and which individuals will get the notifications. The address field 72 allows the user to input the address of the incident for transmission to the coordination service 16, which analyzes and determines which nearby individuals are notified based on the area of operations associated with the address.

A user can select a GPS button 80 to provide GPS location of the at least one technician device 10 and can set the GPS location as the incident location. In certain aspects, the address field 72 is configured to accept multiple addresses for identifying various conditions such as, but not limited to, loading zones, rally points, supply points, points of interest, and other appropriate conditions. After the plurality of event data fields 64 have been entered and transmitted to the coordination service 16, the processor 48 of the coordination service 16 is configured to determine who to notify and/or disseminate the event data 60 to including, but not limited to, group members, supervisors, and other appropriate personnel.

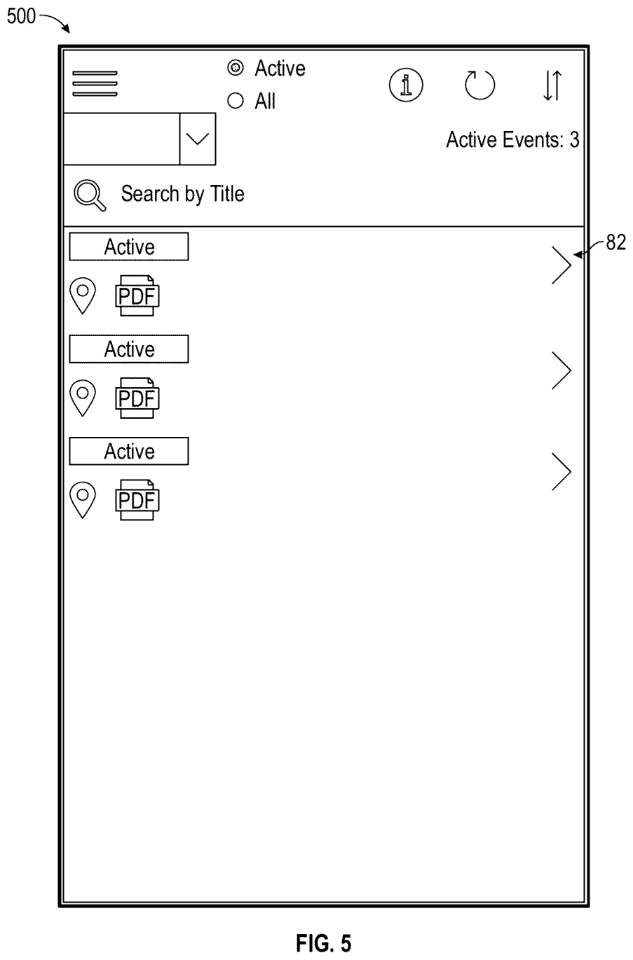

As illustrated in the screenshot 500 in FIG. 5, the app 39, via the coordination service 16, is configured to display a listing of incidents 82, which can be selectively displayed on the at least one technician device 10, the at least one group member device 12, and the at least one administrator device 14. The processor 48 of the coordination service 16 is configured to determine which individuals and devices are able to view which incidents based on, but not limited to, type of incident, nature of incident, classification of incident, location of incident, deployed personnel, and other appropriate factors. The app 39 is configured to allow a user to toggle between historic events and active events, filter based on title or location, select a waypoint of an event and be directed to a GPS navigation either directly on the device or via a web browser, select a drill down button to display additional information on an particular event or incident, view how many active incidents there are at a given time, download a finalized version of an incident report that includes, but is not limited to, all the event data 60 including updates and pictures.

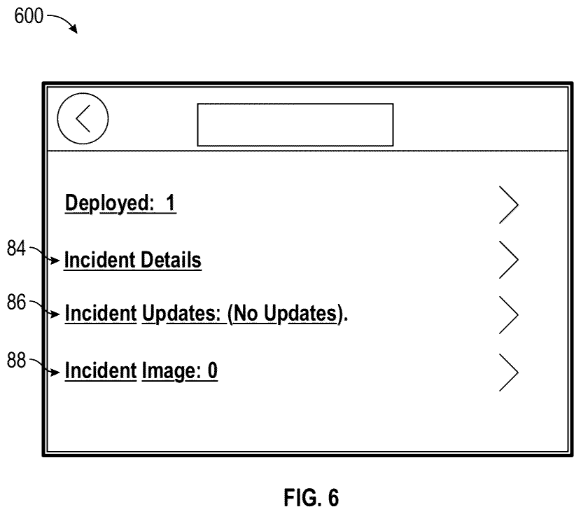

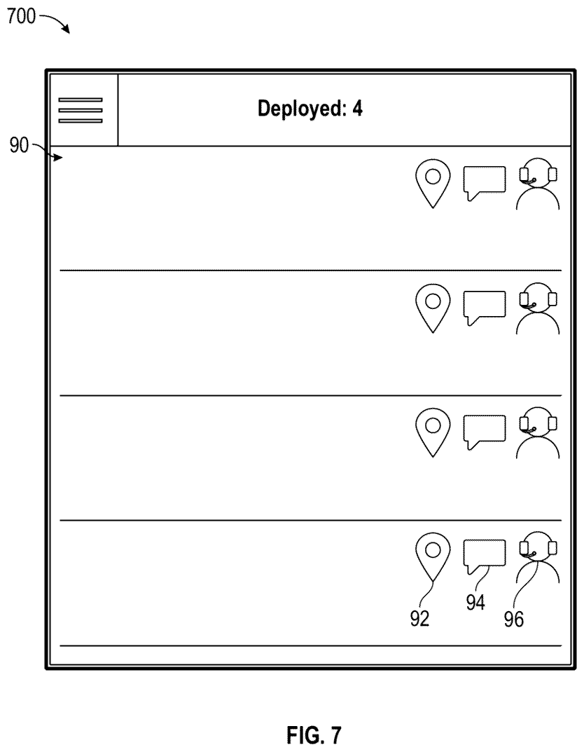

As illustrated in the screenshot 600 in FIG. 6, the app 39, via the coordination service 16, is configured to display incident details 84, incident updates 86, and incident images 88. As illustrated in the screenshot 700 in FIG. 7, the app 39, via the coordination service 16, is configured to display the number of deployed individuals. In certain aspects, the app 39 is configured to allow a user to select a deployed GPS button 92 for a particular deployed individual to display the location or provide a GPS navigation link of the location. In certain aspects, the app 39 is configured to, responsive to selection of a text button 94 associated with a particular deployed individual, display a text field for the user to enter text to send to the particular deployed individual. In certain aspects, the app 39 is configured to, responsive to selection of a call button 96 associated with a particular deployed individual, connect the user to the particular deployed individual via a telephonic call, messaging capabilities, and electronic mail features, tied into the technician's device.

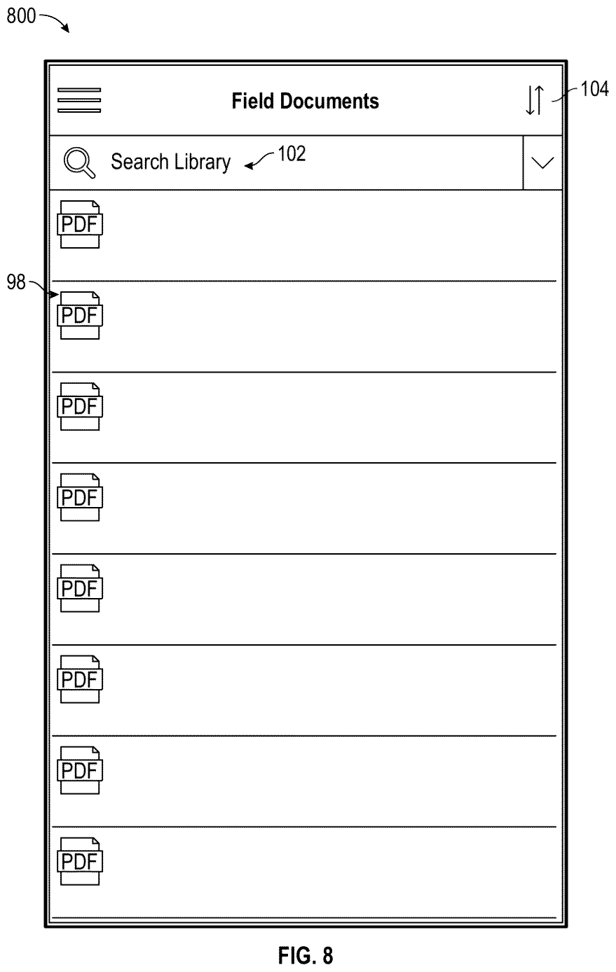

As illustrated in the screenshot 800 in FIG. 8, the app 39, via the coordination service 16, is configured to display a field document list 98. A user can click on a document icon of a plurality of documents. A user can enter text in a document search bar 102 to search for a particular document. A user can filter the field document list 98 by toggling the document filter icon 104.

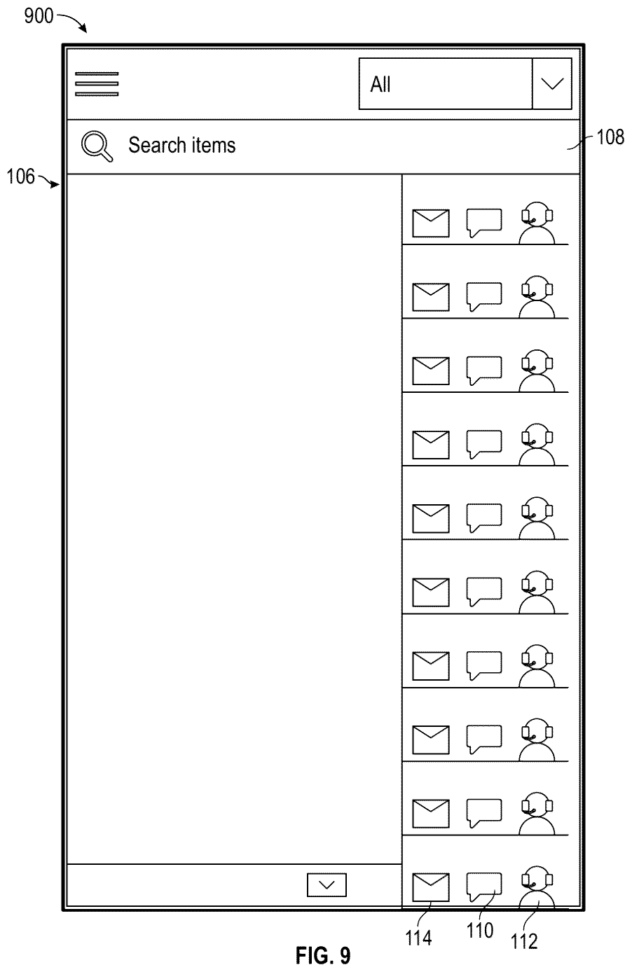

As illustrated in the screenshot 900 in FIG. 9, the app 39, via the coordination service 16, is configured to display a personnel directory 106. A user can search for an individual via the personnel search bar 108. In certain aspects, the app 39 is configured to, responsive to selection of a personnel text button 110 associated with a particular individual, display a text field for the user to enter text to send to the particular individual. In certain aspects, the app 39 is configured to, responsive to selection of a personnel call button 112 associated with a particular individual, connect the user to the particular individual via a call. In certain aspects, the app 39 is configured to, responsive to selection of a personnel email button 114 associated with a particular individual, display an email field for the user to enter text to send an email to the particular individual.

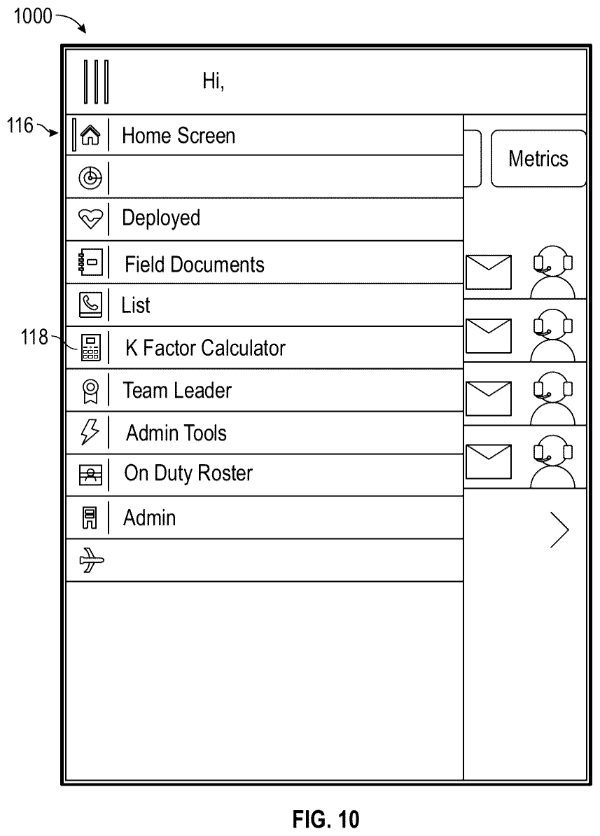

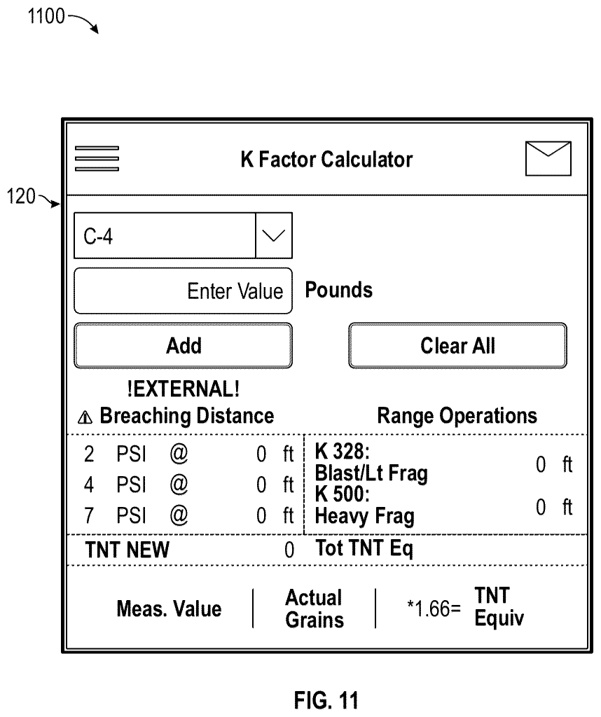

As illustrated in the screenshot 1000 in FIG. 10, the app 39, via the coordination service 16, is configured to display a function list 116. A user can select a calculator button 118 to display a calculator 120, as illustrated in the screenshot 1100 in FIG. 11. The app 39, via the coordination service 16, is configured to, response to selection of the calculator button 118, the calculator 120. In certain aspects, the calculator 120 is a K factor calculator that is used to automate the calculation of a K factor, which is an explosives weight calculation of TNT equivalent. The K factor calculation is based on what type of explosive with variable pressure zones. In certain aspects, the app 39 is configured to display map overlays of concentric damage rings for potential damage to surrounding areas and evacuation zones.

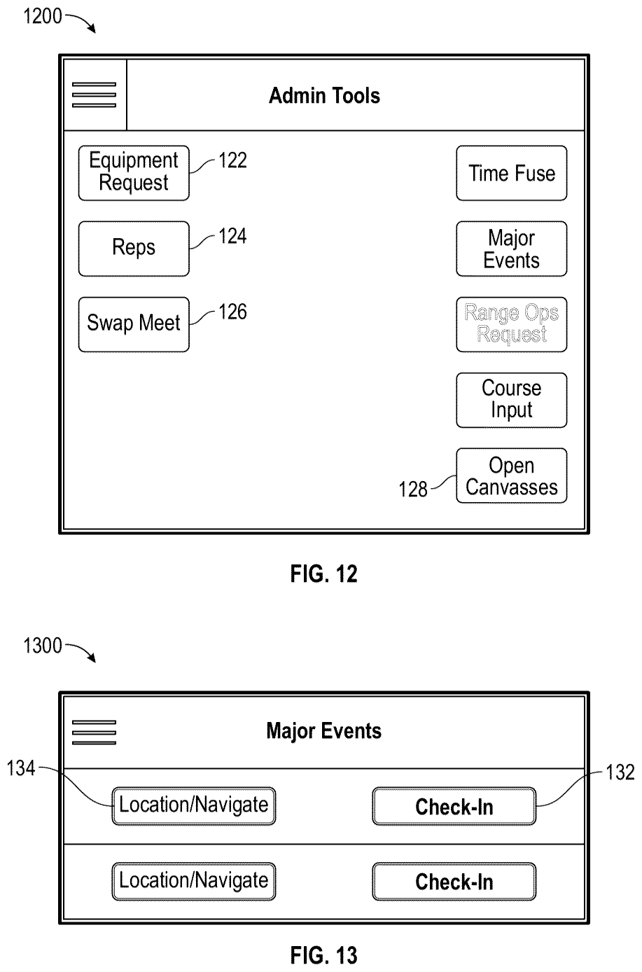

As illustrated in the screenshot 1200 in FIG. 12, the app 39, via the coordination service 16, is configured to display an equipment request button 122, which, responsive to selection, allows a user to make equipment requests. The app 39, via the coordination service 16, is configured to display a reps button 124, which, responsive to selection, allows a user to view additional personnel for union or other representatives. The app 39, via the coordination service 16, is configured to display a swap meet button 126, which, responsive to selection, allows a user to conduct a gear swap. The app 39, via the coordination service 16, is configured to display a open canvas button 128, which, responsive to selection, allows an administrator using the at least one administrator device 14 to create canvasses for deployments, promotions, and special assignments. When a user applies for a special assignment, he will select a team leader and supervisor for approval. This will automatically get submitted into a pool of approved candidates. The final list of individuals will include a sheet for each candidate, and then include a list of number of deployments, qualifications, and training conducted. In certain aspects, a range of operations approval request where users can select the conditions of the range and plan of events for approval is provided.

As illustrated in the screenshot 1300 in FIG. 13, the app 39, via the coordination service 16, is configured to display a list of major events 130. The app 39, via the coordination service 16, is configured to allow a user to check in and check out of locations via a check-in/out button 132. The app 39, via the coordination service 16, is configured to allow a user to view where various locations are and navigate to them via a location/navigate button 134.

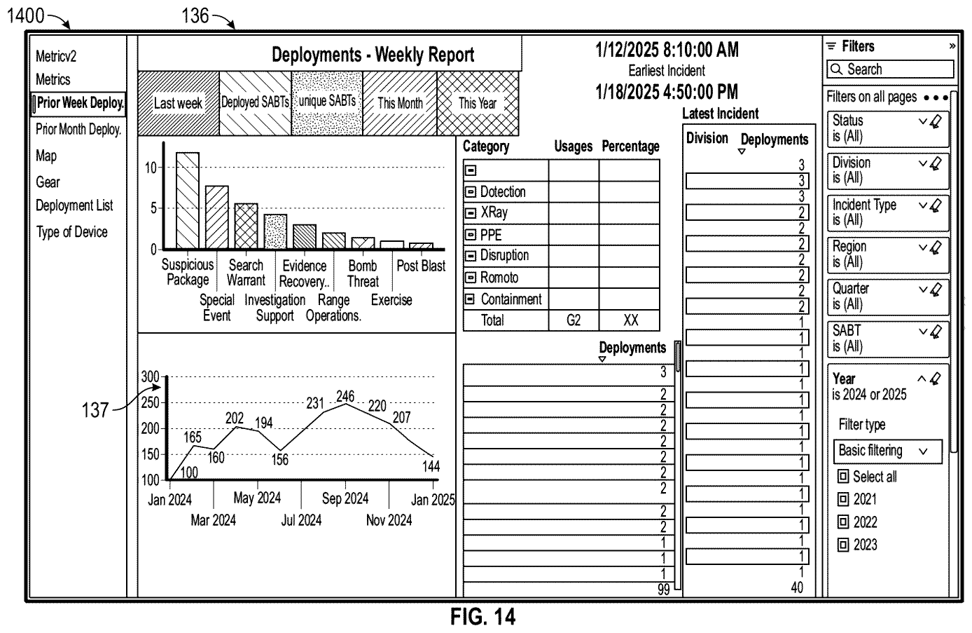

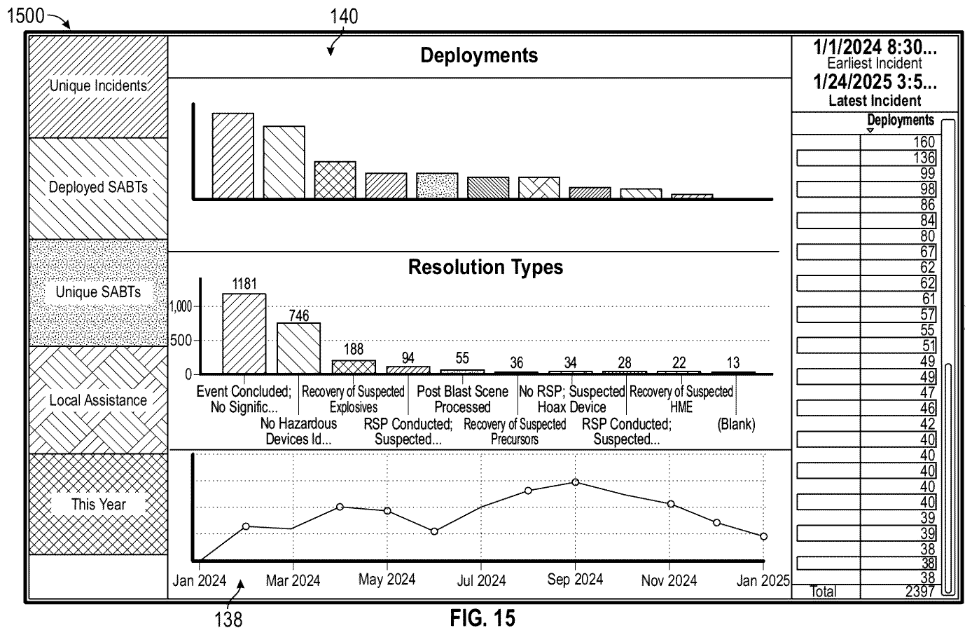

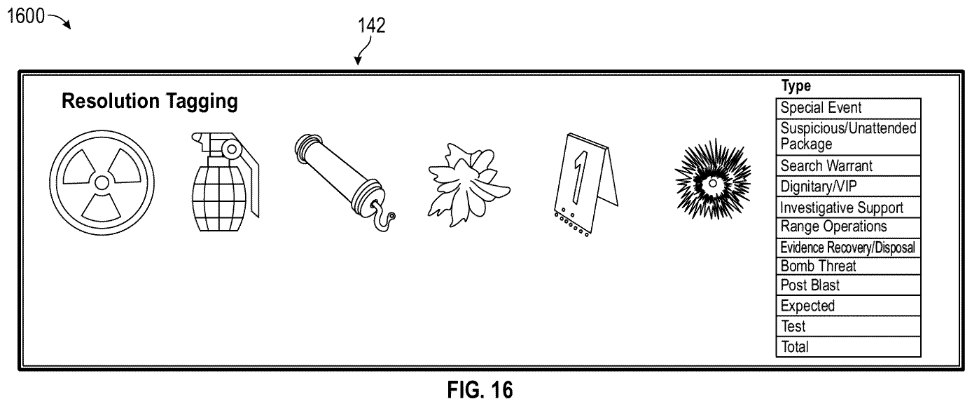

As illustrated in the screenshot 1400 in FIG. 14, the app 39, via the coordination service 16, is configured to display a dashboard 136 including graphical representations 137. The graphical representations 137 are real-time representations of the data associated with a plurality of models such as the models in the memory 50. However, the real-time representations can include data associated with additional and/or other models. In some embodiments, the real-time representations are configured to be dynamically updated based on any updates and/or changes to the underlying data, thus allowing for a user accessing the dashboard 136 to review the most current information. As illustrated in the detailed screenshot 1500 in FIG. 15, the app 39, via the coordination service 16, is configured to display graphs 138 and charts 140 in the dashboard 136. As illustrated in the detailed screenshot 1600 in FIG. 16, the app 39, via the coordination service 16, is configured to display resolution tagging 142, which can allow for a user to tag how an incident resolved.

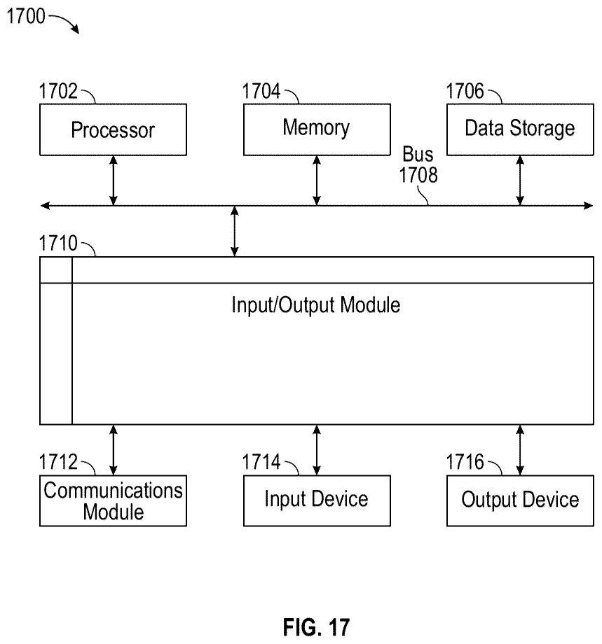

FIG. 17 is a block diagram illustrating an example computer system 1700 with which the at least one technician device 10, to which the at least one group member device 12, the at least one administrator device 14, the coordination service 16, the coordination database 18, and the at least one provider service 20 of FIG. 2 can be implemented. In certain aspects, the computer system 1700 may be implemented using hardware or a combination of software and hardware, either in a dedicated server, or integrated into another entity, or distributed across multiple entities.

Computer system 1700 (e.g., the at least one technician device 10, to which the at least one group member device 12, the at least one administrator device 14, the coordination service 16, the coordination database 18, and the at least one provider service 20) includes a bus 1708 or other communication mechanism for communicating information, and a processor 1702 (e.g., the processor 36, 40, 44, 48, 52, 56) coupled with bus 1708 for processing information. According to one aspect, the computer system 1700 can be a cloud computing server of an IaaS that is able to support PaaS and SaaS services.

Computer system 1700 can include, in addition to hardware, code that creates an execution environment for the computer program in question, e.g., code that constitutes processor firmware, a protocol stack, a database management system, an operating system, or a combination of one or more of them stored in an included memory 1704 (e.g., the memory 38, 42, 46, 50, 54, 58), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1708 for storing information and instructions to be executed by processor 1702. The processor 1702 and the memory 1704 can be supplemented by, or incorporated in, special purpose logic circuitry.

The instructions may be stored in the memory 1704 and implemented in one or more computer program products, e.g., one or more modules of computer program instructions encoded on a computer readable medium for execution by, or to control the operation of, the computer system 1700.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 1700 further includes a data storage device 1706 such as a magnetic disk or optical disk, coupled to bus 1708 for storing information and instructions. Computer system 1700 may be coupled via input/output module 1710 to various devices. The input/output module 1710 can be any input/output module. Example input/output modules 1710 include data ports such as USB ports. In addition, input/output module 1710 may be provided in communication with processor 1702, so as to enable near area communication of computer system 1700 with other devices. The input/output module 1710 may provide, for example, for wired communication in some implementations, or for wireless communication in other implementations, and multiple interfaces may also be used. The input/output module 1710 is configured to connect to a communications module 1712. Example communications modules 1712 (e.g., the communications module 24, 26, 28, 30, 32, 34) include networking interface cards, such as Ethernet cards and modems.

In certain aspects, the input/output module 1710 is configured to connect to a plurality of devices, such as an input device 1714 and/or an output device 1716. Example input devices 1714 include a keyboard and a pointing device, e.g., a mouse or a trackball, by which a user can provide input to the computer system 1700. Other kinds of input devices 1714 can be used to provide for interaction with a user as well, such as a tactile input device, visual input device, audio input device, or brain-computer interface device.

According to one aspect of the present disclosure the at least one technician device 10, to which the at least one group member device 12, the at least one administrator device 14, the coordination service 16, the coordination database 18, and the at least one provider service 20 can be implemented using a computer system 1700 in response to processor 1702 executing one or more sequences of one or more instructions contained in memory 1704. Such instructions may be read into memory 1704 from another machine-readable medium, such as data storage device 1706. Execution of the sequences of instructions contained in main memory 1704 causes processor 1702 to perform the process steps described herein. One or more processors in a multi-processing arrangement may also be employed to execute the sequences of instructions contained in memory 1704. Processor 1702 may process the executable instructions and/or data structures by remotely accessing the computer program product, for example by downloading the executable instructions and/or data structures from a remote server through communications module 1712 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 1702 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 1708. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together into a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method, comprising:
communicably coupling a plurality of data models;
receiving at least one data change associated with at least one data model of the plurality of data models, the at least one data change associated with a data type;
responsive to receiving the at least one data change, determining, based on the data type, a subset of data models of the plurality of data models;
determining a set of data changes based on the subset of data models and the at least one data change;
dynamically updating each data model of the subset of data models based on the set of data changes to define an updated plurality of data models; and
displaying a graphical user interface including real-time representations of the updated plurality of data models.

2. The method of claim 1, wherein the plurality of data models include at least one of an equipment model, a training model, a personnel model, an explosive model, a financial model, or an event management model.

3. The method of claim 1, wherein the at least one data change is associated with an equipment model, wherein the method further includes:
receiving, via the equipment model, an input associated with at least one equipment of a plurality of equipment;
determining, via the equipment model, based on the input, at least one profile update; and
updating profiles associated with the plurality of equipment based on the at least one profile update, wherein the at least one data change include the at least one profile update.

4. The method of claim 3, wherein the plurality of equipment includes equipment associated with explosives.

5. The method of claim 1, further comprising:
generating an aggregate report associated with at least one data model of the plurality of data models.

6. The method of claim 1, wherein the at least one data change is associated with a training model, the method further includes:
receiving an input associated with a training event for a user, the user associated with a user profile;
determining, based on the training event, at least one training category; and
updating, based on the at least one training category and the input, the user profile, wherein the at least one data change includes the updating of the user profile.

7. The method of claim 6, wherein the method further includes:
generating, based on the user profile, at least one metric associated with the user profile; and
generating a report associated with the at least one metric and/or the user profile.

8. The method of claim 1, wherein receiving the at least one data change includes automatically detecting the at least one data change.

9. A system comprising:
a memory comprising instructions; and
a processor operatively coupled to the memory, the processor configured to execute the instructions to:
communicably couple a plurality of data models;
receive at least one data change associated with at least one data model of the plurality of data models, the at least one data change associated with a data type;
responsive to receiving the at least one data change, determine, based on the data type, a subset of data models of the plurality of data models;
determine a set of data changes based on the subset of data models and the at least one data change;
dynamically update each data model of the subset of data models based on the set of data changes to define an updated plurality of data models; and
display a graphical user interface including real-time representations of the updated plurality of data models.

10. The system of claim 9, wherein at least one data change is associated with a personnel model, the processor is further configured to:
generate, based on scheduling information, a dynamic schedule associated with personnel;
determine a status change associated with the personnel has occurred; and
automatically updating, based on the status change, the dynamic schedule, wherein the at least one data change includes the updating of the dynamic schedule.

11. The system of claim 9, wherein the at least one data change is associated with an explosive model, wherein the processor is further configured to:
activate an evidence collection mode based on an input from a user, the input including an incident type;
based on the incident type and predefined parameters, generating a plurality of collection steps;
displaying, via a user device, each collection step of the plurality of collection steps;
receiving one or more inputs associated with each collection step, the one or more inputs associated with metadata; and
based on the metadata, enriching the one or more inputs with additional information, wherein the at least one data change includes the one or more inputs.

12. The system of claim 11, wherein the processor is further configured to:
verify, via a verification engine, if the one or more inputs satisfy an input protocol.

13. The system of claim 12, wherein the processor is further configured to:
based on the one or more inputs being verified, generate an evidence package by cryptographically binding the one or more inputs and the additional information.

14. A non-transitory processor-readable medium storing code representing instructions to be executed by one or more processors, the instructions comprising code to cause the one or more processors to:
communicably couple a plurality of data models;
receive at least one data change associated with at least one data model of the plurality of data models, the at least one data change associated with a data type;
responsive to receiving the at least one data change, determine, based on the data type, a subset of data models of the plurality of data models;
determine a set of data changes based on the subset of data models and the at least one data change;
dynamically update each data model of the subset of data models based on the set of data changes to define an updated plurality of data models; and
display a graphical user interface including real-time representations of the updated plurality of data models.

15. The non-transitory processor-readable medium of claim 14, wherein the at least one data change is associated with an explosive model, wherein the instructions comprise code to further cause the one or more processors to:
receive at least one explosive parameter from a user device;
determine a blast scaling value based on the at least one explosive parameter;
based on the blast scaling value, determine a hazard zone and an evacuation zone; and
generate, based on the hazard zone and the evacuation zone, a map overlay.

16. The non-transitory processor-readable medium of claim 15, wherein the instructions comprise code to further cause the one or more processors to:
generate, based on the at least one explosive parameter, the blast scaling value, and the map overlay, an evacuation report; and
in response to determining a change to the at least one explosive parameter, the blast scaling value, or the map overlay, dynamically updating the evacuation report.

17. The non-transitory processor-readable medium of claim 14, wherein the graphical user interface is a first graphical user interface, wherein the instructions comprise code to further cause the one or more processors to:
receive, form a user device, an input associated with an incident, the input comprising incident information;
based on the incident information, determining a subset of resources from a plurality of resources;
displaying, via a second graphical user interface on the user device, graphical representations of the subset of resources;
receiving one or more user inputs associated with the subset of resources, wherein the one or more user inputs is associated with a user interaction with the graphical representations;
generating, based on the one or more user inputs and the incident information, an incident report; and
automatically updating, based on the incident report, a data management system.

18. The non-transitory processor-readable medium of claim 17, wherein updating the data management system includes updating a dashboard.

19. The non-transitory processor-readable medium of claim 17, wherein the incident is associated with an explosive.

20. The non-transitory processor-readable medium of claim 17, wherein the incident information includes a geolocation, wherein determining the subset of resources includes determining personnel within a predetermined distance of the geolocation.
